(19) United States
(12) Patent Application Publication
(10) Pub. No.: US 2008/0227079 A1
(43) Pub. Date: Sep. 18, 2008

(54) Method, Apparatus and Computer Program Code for Automation of Assessment Using Rubrics

(75) Inventors: Richard F. Boehme, Carmel, NY (US); Peter G. Fairweather, Yorktown Heights, NY (US); Umer Farooq, State College, PA (US); Dick Lam, Danbury, CT (US); Kevin Singley, Skillman, NJ (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 12/051,347

(22) Filed: Mar. 19, 2008

Related U.S. Application Data
(63) Continuation of application No. 10/722,926, filed on Nov. 26, 2003.

(51) Int. Cl. G09B 7/00

(52) U.S. Cl. 434/322

(57) ABSTRACT

A method and apparatus is provided for facilitating the assessment of entities including persons, standards, and/or environments. Contextual information, such as that representing the assessment by a teacher for a student, can be captured by a portable ingestion device and recorded onto media for processing and mapping into rubrics. Assessments can be optionally processed for further analysis.

### TECHNICAL FIELD

This invention relates generally to a method and apparatus for facilitating the assessment of entities, including people, standards, and/or environments. As an example, the invention relates to facilitating the assessment of students by teachers, using rubric scores.

### BACKGROUND

Assessing learners, such as students, is a complex undertaking tormentors, such as teachers, because of the intricacies involved in learner management, grading consistency, mentor professional development, and conformance to standards/benchmarks. In performing assessments after the fact, mentors often do not recollect the context of learners and their interactions within the teaching and learning environment. For example, an elementary school teacher who assesses students after class may not recollect a particular student and his/her interaction with the student.

Consider a problem scenario involving a class activity where groups of students are dissecting a frog. As the teacher walks around to grade dissection quality, she observes that Group B did not dissect their frog as well as Group A and she assigns Group B a quantitative score of 6 out of 10. After finishing her assessment of the other three groups (C, D and E), the teacher realizes that Group B could have perhaps deserved a better grade relative to the three other groups, but the teacher has difficulty recollecting the dissection quality because of reliance on mere memory and because the artifacts of the dissection have been discarded. The teacher also cannot compare the final dissected artifacts for grading consistency.

One solution to this problem is for the teacher to use traditional paper and pencil to note details on the artifacts, and later refer to them for consistent assessment. However, this method is time-consuming for the teacher, who must record group names and details of dissection quality, and then assimilate this information to facilitate authentic (accurate) assessment to be done after class. It is not practical and perhaps impossible to capture the richness of the performance with written comments and thus information will likely be lost.

The problems with the prior art method of manual entry can be summarized as follows:

1. The method of manual entry is time consuming and inaccurate. This method distracts teachers from their primary task of teaching in the classroom.
2. This method is difficult to share with other collaborators (e.g., other teachers).
3. This method is often not executed due to lack of time, and hence, teacher tries to cognitively accomplish the task, relying on mere memory, which is inefficient and often inaccurate.

Moreover, if the teacher wishes to Web-cast her collected observations for students and parents, the collected observations exist only on paper or in the teacher's mind and must first be converted to electronic format.

U.S. Pat. No. 6,513,046, titled “Storing and recalling information to augment human memories” and U.S. Pat. No. 6,405,226 titled “System and method for taggable digital portfolio creation and report generation” both relate to storage and access of contextual information. These patents do not, however, disclose applying contextual information to the assessment of entities.

### SUMMARY OF THE PREFERRED EMBODIMENTS

The foregoing and other problems are overcome, and other advantages are realized, in accordance with the presently preferred embodiments of these teachings.

The teachings of this invention are directed to a method and apparatus for assessing an entity that maps assessment information into rubric information associated with a particular assessment. The rubric information can yield scoring information to rank assessments associated with each entity.

In one embodiment of the invention, a method includes the steps of selecting a rubric having associated rubric information, inputting assessment input information associated with an entity, mapping the assessment input information to the rubric information to yield results of the mapping and storing the results of the mapping. Preferably, the results are stored in a persistent medium.

In another embodiment of the invention, an apparatus is configured for performing the steps of selecting a rubric having associated rubric information, inputting assessment input information associated with an entity, mapping the assessment input information to the rubric information to yield results of the mapping and storing the results of the mapping. Preferably, the results are stored in a persistent medium.

In some embodiments the apparatus is a computing device executing software performing at least a portion of one or more of said selecting, inputting, mapping and storing steps. In some embodiments, the apparatus is portable computing device such as a personal digital assistant, a handheld computer or similar device.

In some embodiments, the apparatus can be configured to include a microphone for input and storage of audio information, and/or configured to include a camera for input and storage of video information, and/or configured to include a communications port for communicating information between the apparatus and a location remote from the apparatus.

The assessment input information can be represented by any machine readable representation including multimedia, audio, video, images, still pictures, type, freehand writing and any representation that can be interpreted in electronic format. The step of mapping of said assessment input information to rubric information can employ any information deciphering methodologies including artificial intelligence, natural language processing with speech recognition, hand writing recognition and text scanning.

Optionally, rubric information may be stored local to or communicated between a remote location and the computing device. Optionally, the results of the mapping step may be stored local to or communicated and stored at a location remote from the computing device.

In some embodiments, a procedure in accordance with these teachings may be embodied as program code on a medium that is readable by a computer. The program code being used to direct operation of a computer for assessing an entity. The program code includes a program code segment for selecting a rubric having associated rubric information, a program code segment for inputting assessment input information associated with an entity, a program code segment for mapping the assessment input information to the rubric information to yield results of the mapping step and a program code segment for storing the results of the mapping.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram illustrating an example of an “Oral Presentation” rubric.

FIGS. 2A-2D are collectively an illustration of the “Oral Presentation” rubric of FIG. 1 represented in Extensible Markup Language (XML) format.

FIG. 3 is a flow diagram illustrating the overall work flow of an embodiment of the system.

FIG. 4 is a flow diagram illustrating an example of how an embodiment of the system can be used by a teacher to assess a student.

FIG. 5 is a block diagram illustrating some examples of the input types that can be provided to the system.

FIG. 6 is a block diagram illustrating some examples of the types of input specifications that can be provided to the system.

FIG. 7 is a block diagram illustrating some examples of how an embodiment of the automated system can be deployed.

FIG. 8 is a block diagram illustrating the classification process for an assessment input specification.

FIG. 9 is a block diagram illustrating an example of the scoring process when a benchmark match is found.

FIG. 10 is a block diagram that illustrates an example of the scoring process for evolving rubrics.

FIG. 11 is an illustration of an example of student information represented in Extensible Markup Language (XML) format.

FIG. 12 is a block diagram that illustrating an example of storing rubrics represented in XML format.

FIG. 13 is a block diagram illustrating an example of storing student information represented in XML format.

FIG. 14 is a flow diagram illustrating analysis of assessments.

FIG. 15A is an illustration of a user capturing contextual information for use as an assessment.

FIG. 15B is an illustration of a user capturing a picture of student work via a camera for assessment, development of rubrics and Web-casting.

### DETAILED DESCRIPTION OF THE PREFERRED EMBODIMENTS

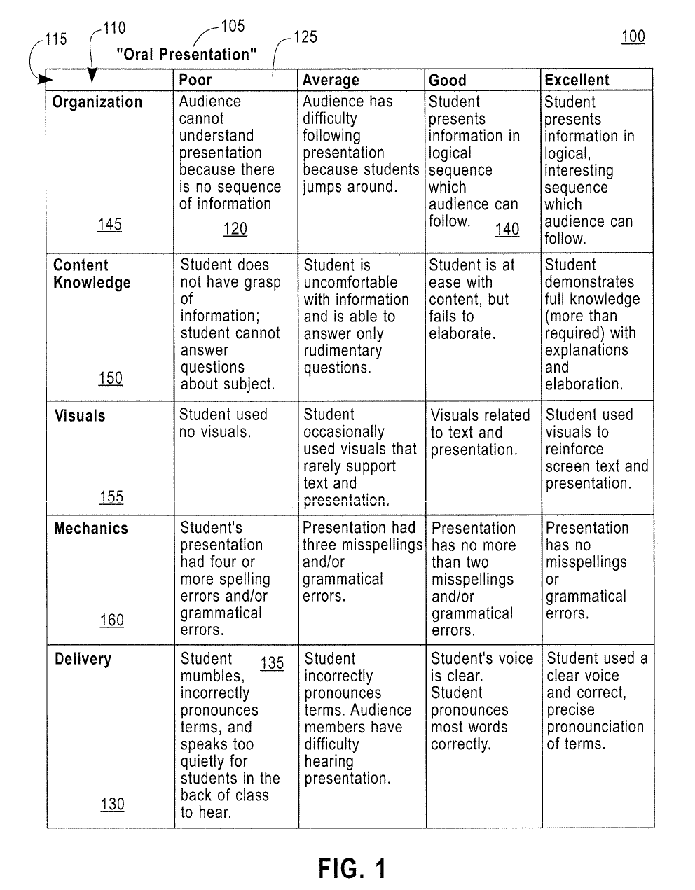

FIG. 1 is a block diagram illustrating an example of an “Oral Presentation” rubric 100. The rubric 100 is arranged in a tabular and human readable format for ease of reading. The rubric 100 can also be represented in other formats such as Extensible Markup Language (XML). In this embodiment, the rubric 100 includes a title element and criteria, score and benchmark elements. These elements are described below.

1. TITLE: this is a rubric identifier. In this example, it is represented by the text “Oral Presentation” 105. In some embodiments, this element is mandatory.
2. CRITERIA: these represent the assessment categories of the rubric 100. In this example, the criteria are the vertical listed entries in the first (leftmost) column 110 of the rubric 100. The criteria are represented by the text (names) (Organization 145, Content Knowledge 150, Visuals 155, Mechanics 160, Delivery 130). In some embodiments, this element is mandatory.
3. SCORES: these represent the assessment values (results/gradations) that can be assigned for each of the criteria. In this example, scores are the horizontal listed entries in the first (top) row 115 of the rubric 100. The scores are represented by the text (names) (Poor, Average, flood, Excellent). In some embodiments, this element is mandatory.
4. BENCHMARKS: these are the examples of standards of an assessment that have been assigned to each criteria and each associated score for that criteria. For this example rubric 100, there are twenty benchmarks. Each benchmark corresponds to each combination of one criteria and one score associated with that criteria. There are 4 scores combined with 5 criteria yielding 20 corresponding benchmarks. A benchmark example of a “Poor” score 125 associated with the criteria “Organization” 145 is represented by the text “Audience cannot understand presentation because there is no sequence of information” 120. Benchmarks are not just limited to being represented by text, but can also be represented by images, such as by pictures of samples (e.g., a scanned image of a writing sample within a writing rubric), or represented by audio, video, multimedia or by any electronic format.

In some embodiments, a rubric can have multiple levels of criteria as well. For example, in the “Oral Presentation” rubric 100, the “Organization” criteria 145 can be broken down to two more criteria: “Presentation Flow” and “Audience Reception”. Within a computer system, these multi-level criteria can be represented by pull-down menus or by any other (user) interface technique for representing multiple dimensions of information associated with a rubric.

The benchmarks can also be represented by hyperlinks to locations on the Internet providing training information or providing standard examples of benchmarks. In some embodiments, there can be multiple benchmarks corresponding to each criteria and score combination. Benchmarks may be represented differently (in different formats). For example, one benchmark may be represented by text and another benchmark may be represented by an image, such as a picture.

As is the case for multi-level criteria, multi-level benchmarks can be represented by pull-down menus or by any other (user) interface technique for representing multiple dimensions of information associated with a rubric. In some embodiments, a rubric can also have one or more optional scoring cells for each criteria which are aggregated to provide a total score for the entire rubric.

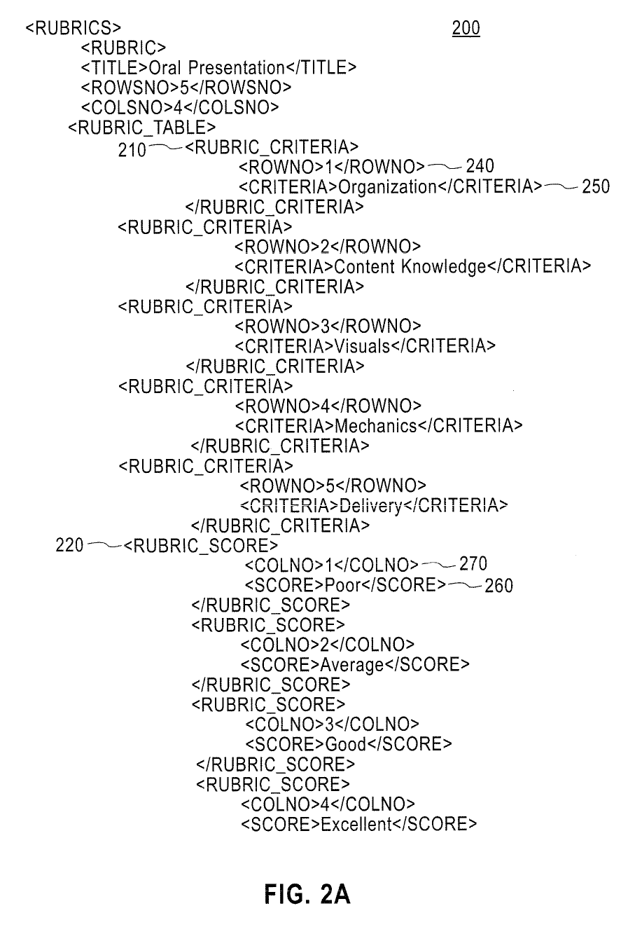

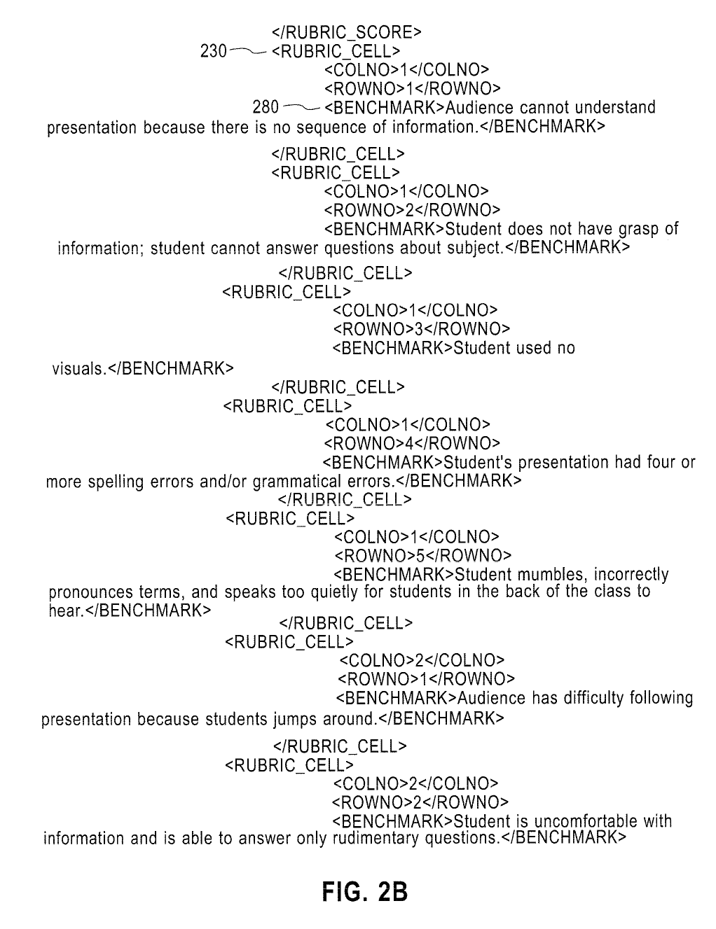

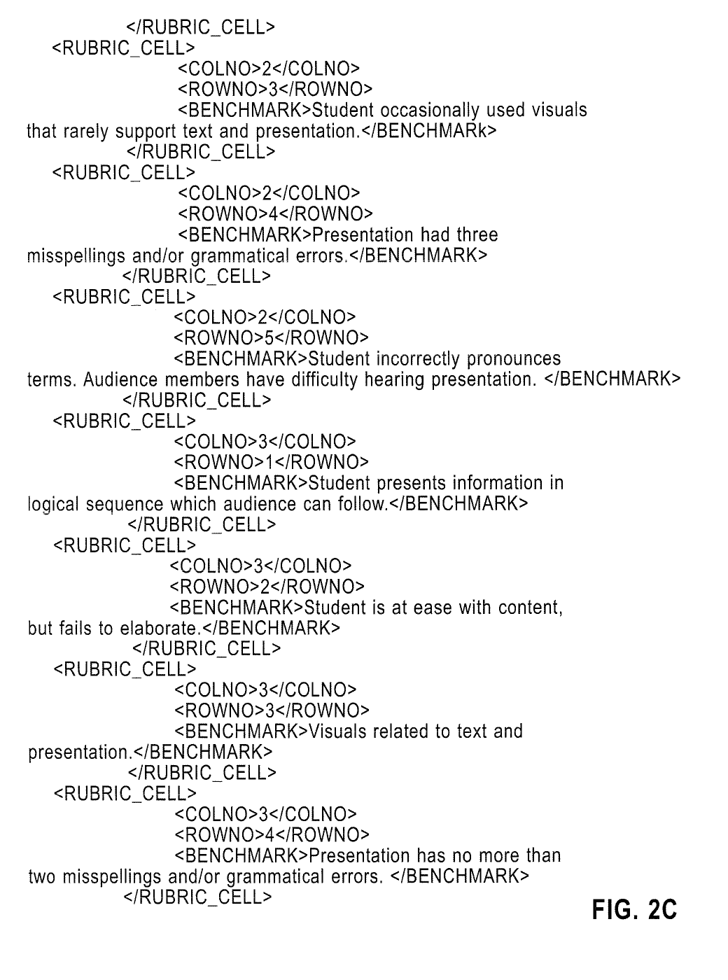

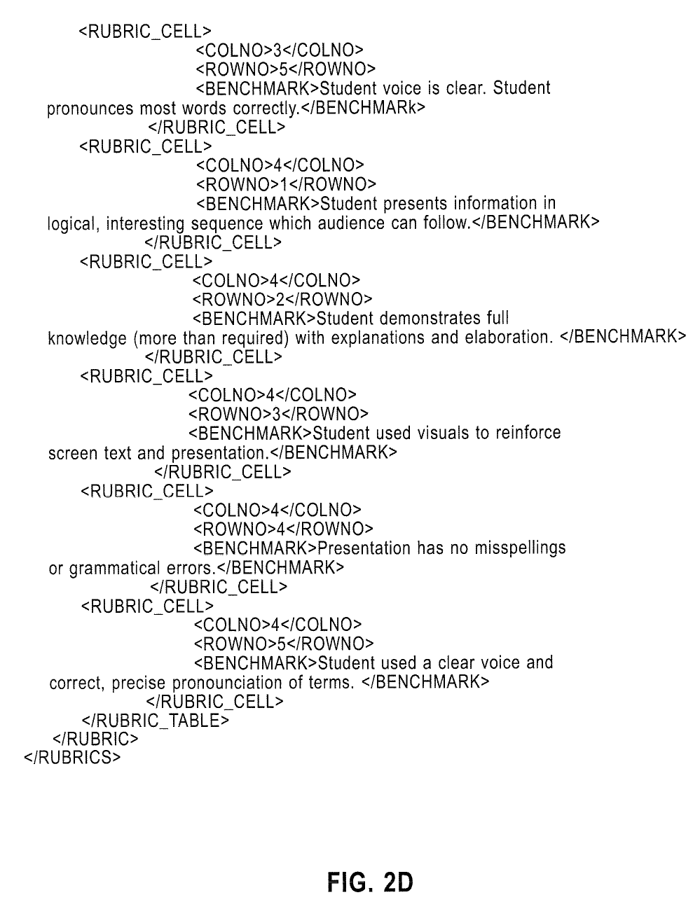

FIGS. 2A-2D are collectively an illustration 200 of the “Oral Presentation” rubric 100 of FIG. 1 represented in Extensible Markup Language (XML) format. The XML format is just another one of many ways to represent a rubric. Note that the criteria, scores, table cells and benchmarks of FIG. 1 are represented in XML via the XML tags “<RUBRIC CRITERIA> 210, “<RUBRIC SCORE>” 220, <RUBRIC_CELL> 230 and “<BENCHMARK>” 280.

Each criteria is associated with a row of the table 100. In XML, each criteria is identified via the <CRITERIA> 250 XML tag and each associated row is identified via the <ROWNO> 240 XML tag.

Each score is associated with a column of the table 100. In XML, each score is identified via the <SCORE> 260 XML tag and each associated column is identified via the <COLNO> 270 XML tag.

Each benchmark is associated with a cell (row and column combination) of the rubric table 100. In XML, each benchmark is identified via the <BENCHMARK> 280 XML tag and each associated cell is identified via the <RUBRIC_CELL> 230 XML tag.

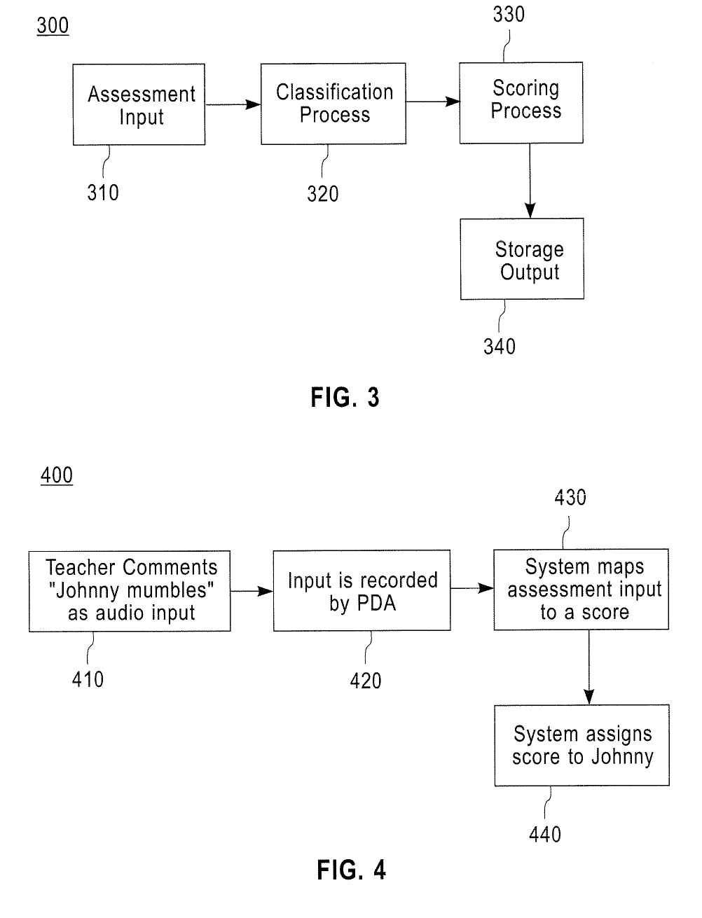

FIG. 3 is a flow diagram 300 illustrating the overall work flow of an embodiment of the system. This embodiment automates the processing of assessments. As shown, the work flow 300 comprises 4 steps that are titled Assessment Input 310, Classification Process 320, Scoring Process 330 and Storage Output 340.

The Assessment Input step 310 is not limited to any one type of input (type of representation such as audio or video), nor limited to just one input (type of information such as benchmark or entity identification), nor limited to a particular source. For example, assessment input information can be accessed from stored digital data, from manual input or from an automated mechanism. Optionally, the assessment input may include information identifying (tagging) the type of input of one or more portions of the assessment input.

The Classification Process step 320 deciphers the assessment input 310 so that the assessment input 310 can be processed by the scoring step 330. In some embodiments, the processing of this step 320 may be based upon the type of input (type of representation) of the assessment input 310.

The Scoring Process step 330 executes a classification algorithm and assigns (matches) the assessment input 310 to matching rubric information associated with a rubric. In some embodiments, this step 330 can map one or more scores for each criteria within a rubric, or for criteria within multiple rubrics.

Steps 320 and 330, collectively perform mapping (deciphering and matching) of assessment Input (information) 310 to matching rubric information associated with a rubric. Matching rubric information includes at least one benchmark (matching benchmark), at least one criteria (matching criteria) and at least one score (matching score) that match assessment input 310.

The Storage Output step 340 stores the result of the mapping (resulting rubric data) into a database or preferably some other type of permanent storage. The results of the mapping include any combination of a matching benchmark, a matching criteria, a matching score, a rubric identifier and an entity identifier. Preferably, the rubric data is stored persistently.

FIG. 4 is a flow diagram 400 illustrating an example of how an embodiment of the system can be used by a teacher to assess a student. In this scenario, a teacher wants to assess a student who is giving an oral presentation. The teacher only specifies (provides) audio input of assessment information to the system. The teacher possesses a portable ingestion device such as a Personal Digital Assistant (PDA, Palm, handheld device etc) for recording her comments/assessments. After classifying the assessment input 320, the system automatically assigns a score 330 to the student's oral presentation.

In the first step 410, the teacher comments that the student (“Johnny”) “mumbles” during the oral presentation using a microphone in her PDA (as audio input). In the next step 420, the teachers comments (assessment input) is recorded by the PDA. Next 430, the system maps (deciphers and matches) the assessment input to a score from a rubric, optionally stored within database, accessible to the PDA. Next at 440, the system assigns the score to the student (Johnny). In some embodiments, the deciphering and/or matching steps are performed by software of the system executing within the PDA. In other embodiments, the deciphering and/or matching steps are performed by software of the system executing remotely from the PDA.

The system maps (deciphers and matches) the audio input “mumbles” for this student with a benchmark “mumbles” associated with the criteria (Delivery 130) and associated with the score (Poor) 125 within the rubric (Oral Presentation) 100. Voice recognition software executing within the PDA or within a remote device can be used to decipher and/or match the audio input “mumbles” with the stored benchmark “mumbles” associated with the criteria Delivery) 130. Once the benchmark match is found, a score (Poor) 125 is assigned to the student for that given benchmark, criteria and rubric 100.

In the above example, the teacher provided an audio input associated with a student's oral presentation and the score was automatically assigned to that student without the requiring the teacher to review the rubric 100, or its associated benchmarks, criteria and scores. This is just one example of an execution of automated features of the system. Each of the above four steps in the system is explained in further detail below.

### Assessment Input

In the preferred embodiment, there are two dimensions (portions) to the assessment input:

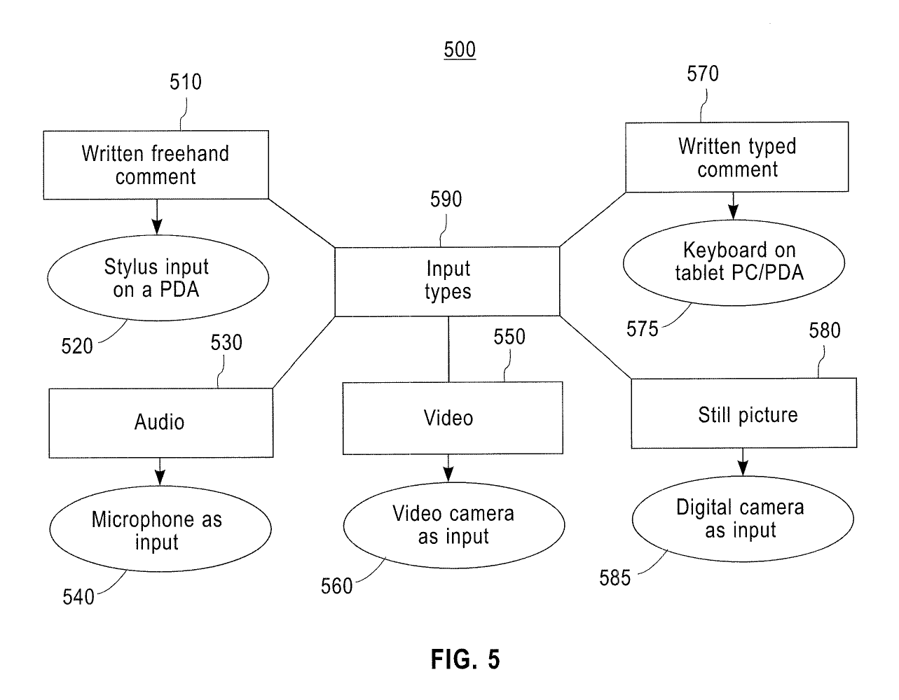

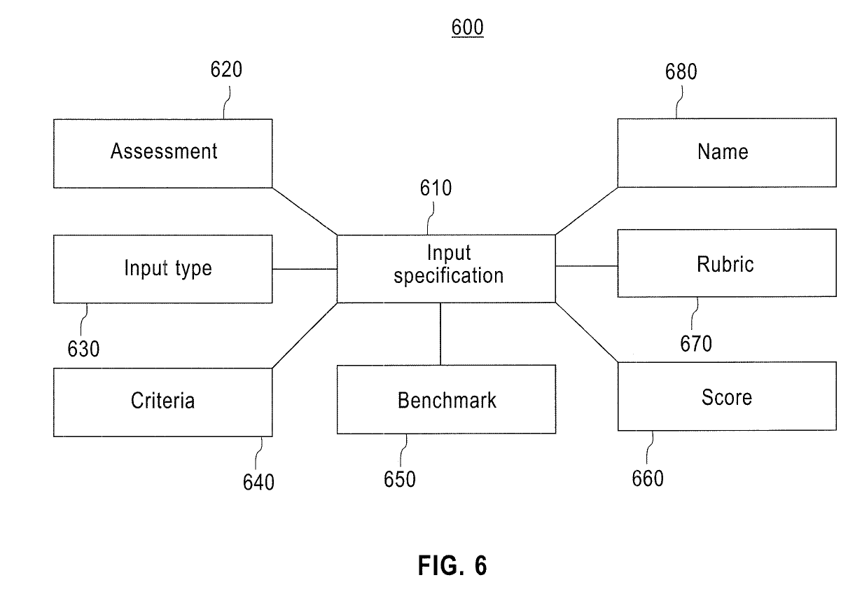

1. Input type: Specifies the form (type of representation) of the assessment input provided to the system (e.g., audio). The input type can be any input that can be interpreted by a machine, such as input in an electronic format. These input types are captured by their respective input devices. For example, a microphone is used to capture audio, a digital camera is used to capture a still picture. See FIG. 5 for an illustration of some examples of input types. Some examples of input types are listed below.
a. Written freehand comment(s)
b. Written typed comment(s)
c. Audio
d. Video
e. Still picture(s)
f. Any form of multimedia
g. Any input that can be interpreted in electronic format
2. Input specification: Specifies the inputs (types of information) that are provided to the system (e.g., student's name, rubric to use, etc). These inputs (types of information) are also referred to as input specification elements. The input specification is provided and represented by at least one of the input types listed above. See FIG. 6 for an illustration of some examples of the types of inputs (types of information) that can be included in input specifications. The input specification can be any or a combination of the following.
a. Assessment(s): this is the comment/assessment by the assess or represented in one of the input types.
b. Name(s): this is the name (identity) of the entity being assessed. In some embodiments, this is an optional field.
c. Input type(s): The assessor can tag the assessment input and/or any other input specification element with an input type (type of representation) circumventing the need for the system to decipher all or a portion of the assessment input. In some embodiments, this is an optional field.
d. Rubric(s): The assessor can specify (identify) the rubric to be used. In some embodiments, this is an optional field.
e. Criteria: The assessor can specify (identify) the criteria for which to match the assessment against. In some embodiments, this can also lead to an evolved rubric. In some embodiments, this is an optional field.
f. Benchmark(s): The assessor can specie (identify) a benchmark for creating an evolved rubric. In some embodiments, this is an optional field.
g. Score(s): The assessor can specify (identify) a score for creating an evolved rubric. In some embodiments, this is an optional field.
h. Any other input specification element that conforms to any of the input types processed by the system.

Thus, the assessor (e.g. teacher) can select levels of assessment by identifying combinations of these input specification elements. Rubric-related input specification elements (i.e. rubric, criteria, benchmark, and score) can also be provided automatically through a teacher's lesson plans for that class. The source of the input type and the input specification can be from any entity that can provide a machine readable format of the assessment input information, such as any of the input types described above, to the system. The name of the person (entity) being assessed can also be captured from (an image) such as a picture of the person (entity). For example, the system can perform face (visual pattern) recognition and associate a name to a face of the person (entity) being assessed.

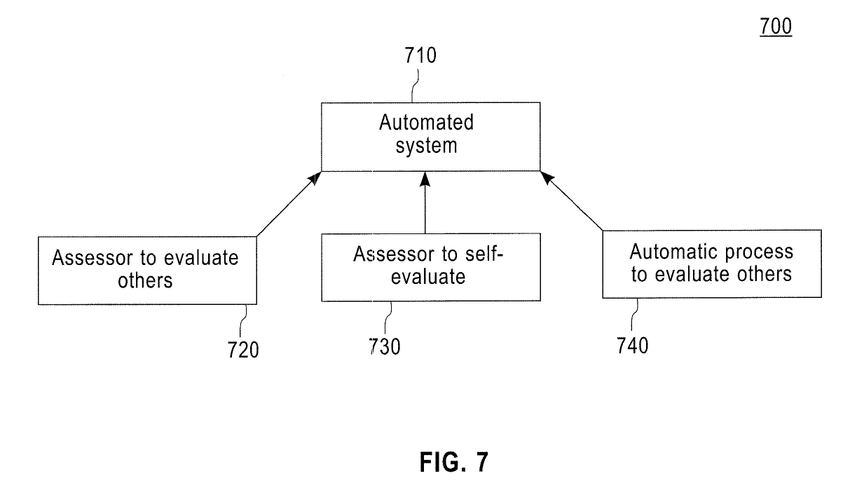

Note that the use of this system is not limited to the assessor (e.g. teacher). The system can be used in the following manner by various entities. See FIG. 7 for an illustration of some examples of assessors. The assessor can be a teacher evaluating a student. The assessor can use the system for self evaluation. The assessor can be an automatic process using the system to evaluate others (other entities). For example, a video camera can be used to assess students without the help (participation) of a teacher. The input is specified using an appropriate interface(s) to the system. Interface techniques can be any of the existing methodologies and tools (e.g., forms, dialog boxes, information visualization techniques, etc).

### Classification Process

The classification process deciphers the input type and input specification of the assessment input to enable the assessment, included within the assessment input, to be processed and scored. This process can be a manual or an automated process. For the automated embodiment, the system deciphers the input type(s) associated with the input specification elements. For example, if the input type is audio (i.e. in the scenario, teacher records that “Johnny mumbles”), the classification process would identify “Johnny” as the name (input specification element) of the student being assessed, “audio” as the pre-specified input type, and “mumbles” as the assessment (input specification element) for that student. There after, an appropriate score(s) is assigned to this particular student (“Johnny”). In another embodiment, a manual process can be used to perform the same process as described for the automated embodiment above.

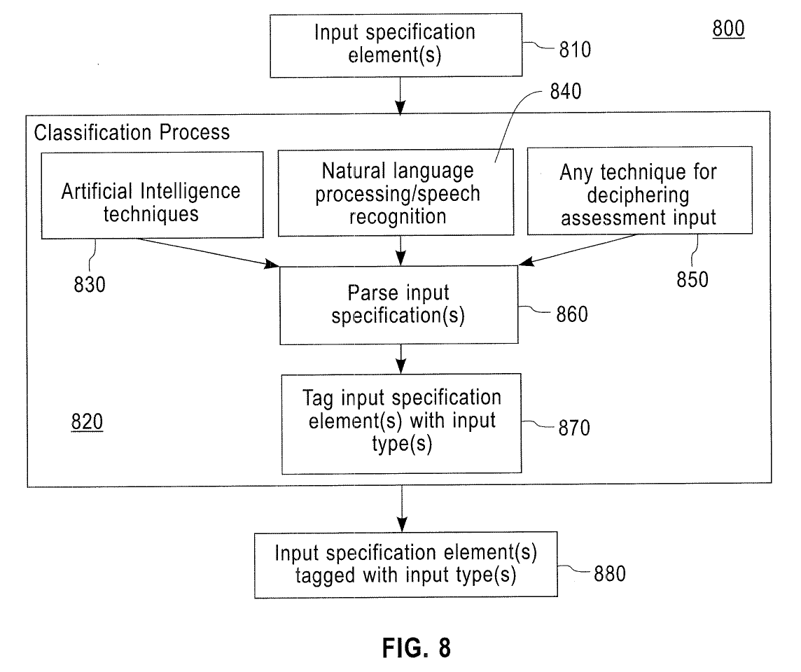

In some embodiments, the classification process is optional, depending on the specificity of the assessment input provided by the assessor to the system. In some embodiments, the assessor can specify both the criteria and score associated with the assessment. The techniques used for classification can be any existing methodology that allows the system to decipher the provided assessment input specification elements. For example, the system could use Artificial Intelligence (AI) techniques to decipher the input type and input specification elements, or use natural language processing with speech recognition to decipher audio input. See FIG. 8 for an illustration of the classification process.

### Scoring Process

Once the system has the input specification elements tagged with the associated input type(s), the system will score the assessment for the student. This scoring can be done, for example, by automatically matching the input specification elements with rubric information (corresponding rubric data) previously selected and available for access by the system. For example, if an input specification including an associated input types is:

Name of the person to be assessed: Johnny
Input type: audio
Assessment: mumbles

In response, the system matches “mumbles” with one of the benchmarks of the “Oral Presentation” rubric 100, if the “Oral Presentation” rubric 100 has been pre-specified (pre-selected) to the system. If not pre-specified, the system matches “mumbles” with any of the benchmarks of all rubrics known to the system. In one scenario, the system automatically detects that “mumbles” corresponds to only the “Oral Presentation” rubric 100.

Once the matching benchmark is found by comparing the audio input with benchmarks known to the system (formats may be converted for comparison; e.g., if input is in audio, and benchmark is in text, then using speech-to-text, audio is converted to text and then compared with the benchmark), the student (Johnny) is scored according to a criteria and a score associated with the matching benchmark.

Note that the comparison operation can be done in a number of ways using existing techniques such as picture (image) matching, pattern matching, format conversion and comparison, or any other similar techniques that can produce a match, a proximity to a match or a ranking of a match. The steps of this example are outlined below:

a. Input specification is “Johnny mumbles” in audio format.
b. The classification process parses out the input specifications and tags them with the appropriate input types.
c. The inputs to the scoring process include the name of the person (“Johnny”), with input type (audio), and an assessment (“mumbles”), with input type audio.
d. The scoring process matches the assessment (“mumbles”) to at least one benchmark within at least one rubric known or specified to the system.

Since the input type is audio and existing benchmarks for the Oral Presentation rubric 100 are represented in text, the audio input is converted to text using, for example, speech-to-text translation techniques.

The translated audio text is compared with all the benchmarks known to the system within the Oral Presentation rubric 100. The assessment (“mumbles”) is matched to the benchmark 135 associated with the criteria (“Delivery”) 130 and the score (“Poor”) 125 by the system, because the association of (“mumbles”) to the criteria (“Delivery”) 130 has been pre-specified to the system via the Oral Presentation rubric 100.

e. When a matching criteria (“Delivery”) 130 is found, the system then matches the assessment (“mumbles”) to the appropriate score associated with the Criteria (“Delivery”) 130. According to the “Oral Presentation” rubric 100 of FIG. 1, the assessment (“mumbles”) matches to the score (“Poor”) 125 in association with the Criteria (“Delivery”) 130. The student “Johnny” would receive a score of “Poor” 125 for the criteria “Delivery” 130 within the context of the “Oral Presentation” rubric 100.
f. The result of the match is provided as input to the storage output process for storing the result, preferably in a persistent medium.
g. Hence, the student (Johnny) has been assessed with respect to the Delivery criteria 130 of his oral presentation

Note that above is just one example of the many possible combinations in which a student may be assessed. Alternatively, the teacher may also provide the name of the rubric to use, the criteria to compare against, or any of the input specifications in association with any of the input types described earlier.

It should further be noted that mapping assessment input information to rubric information can create a new benchmark, or at least one new criteria, or a new rubric within the rubric information during mapping of the assessment input information to the matching benchmark or matching criteria. While this may occur upon a failure of the mapping operation, it may also be the intent of the author or system to create a new benchmark, a new criteria or a new rubric.

FIG. 5 is a block diagram 500 illustrating some examples of the input types that can be provided to the system. The input type can be any combination of the following. By no means is this block diagram 500 exhaustive and it 500 only represents some examples of the various input types that can be associated with input specifications.

As shown, input types 590 include written freehand 510 via stylus input provided by a PDA 520, audio 530 via a microphone 540 as input, video 550 via a video camera 560 as input, a written typed comment 570 via a keyboard provided by a tablet connected to a personal computer (PC) or to a PDA 575, or a still picture (image) 580 via a digital camera 585 as input to the system.

FIG. 6 is a block diagram 600 illustrating some examples of the types of input specifications (input specification elements) that can be provided to the system. The input specification can include any combination of the input specifications shown. By no means is this block diagram 600 exhaustive and it 600 only represents some examples of the various input specifications.

As shown, an input specification element 610 can include information regarding an assessment 620, an input type (type of representation) 630 of the assessment, one or more criteria 640, one or more benchmarks 650, name of the entity being assessed 660, identification of a rubric 670 and a score 680 for the assessment. Optionally, a separate input type for each input specification element can reside within the input specification

FIG. 7 is a block diagram 700 illustrating some examples of how an embodiment of the automated system 710 can be deployed. As shown, the automated system 710 can be deployed by an assessor to evaluate other entities 720, or deployed for self-evaluation by the assessor 730, or deployed automatically for the evaluation of other entities 740 without the participation of the assessor.

FIG. 8 is a block diagram 800 illustrating the classification process for an assessment input specification. This block diagram 800 shows the various techniques that can be used to classify assessment input specification(s), also referred to as assessment input specification element(s), into their respective input types to inform the scoring process 330 of the input types it 330 will be processing. As an example, consider the teacher providing the assessment input specification “Johnny mumbles” to the system in audio format. The output of the classification process would be:

Name of the person to be assessed: Johnny
Input type: audio
Assessment: mumbles

The above name and assessment are input specification elements that are tagged with one input type (audio). Alternatively, in other embodiments, each input specification element is tagged separately. The output of this process 880 (i.e. input specification element(s) tagged with input type(s)) is processed by the scoring process and the storage output process, where the assessment results are stored and/or evolved rubrics are generated.

Each of the assessment input specification element(s) 810 is processed (input type identified/tagged) by techniques including artificial intelligence 830, natural language processing/speech recognition 840 or any other technique for identifying the input type of an assessment input specification element.

Once an input type is identified, an assessment input specification element is parsed 860 and tagged 870 by the classification process 820. By no means is this block diagram 800 exhaustive and it 800 only represents some examples of techniques that can be employed to process the various types of assessment input specification elements.

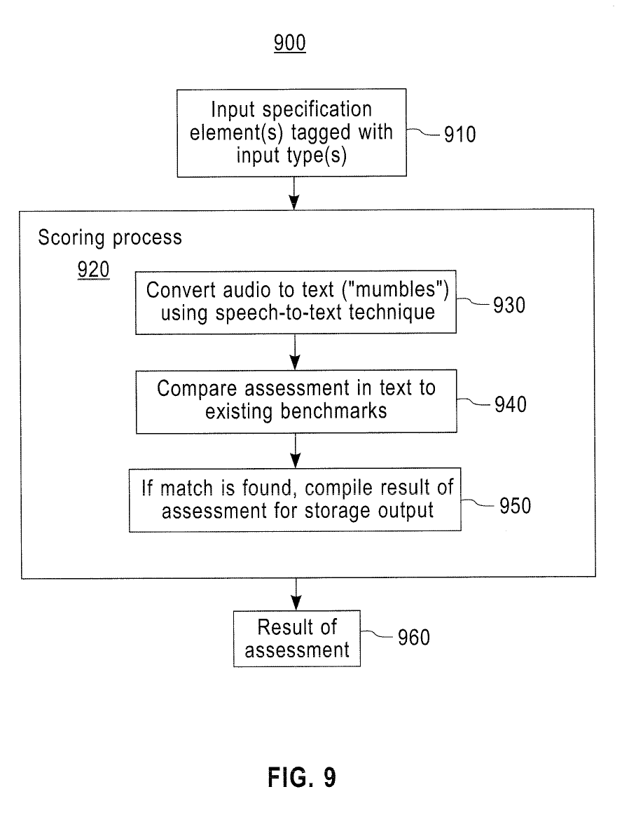

FIG. 9 is a block diagram 900 illustrating an example of the scoring process 920 when a benchmark match is found. The input to the scoring process 920 is provided as input specification element(s) tagged with input type(s) 910. One example of the scoring process is shown here where the input specification elements are:

Name of the person to be assessed: Johnny
Input type: audio
Assessment: mumbles

The output 960 of this process is provided to the storage output process 340 where the scoring results are stored, preferably in some persistent medium.

As shown, one or more input specification elements tagged with input types(s) 910 are provided as input to the scoring process 920. The scoring process 920 converts the audio (“mumbles”) to text using a speech-to-text technique 930. Next, the assessment now represented as text is compared to existing benchmarks 940 known to the system. Next, if a match to an existing benchmark is found, the result of the assessment is compiled for storage output 950. Next, the result of the assessment is output from the scoring process 960.

In some embodiments, if the assessment does not match rubrics known to the system, rubrics known to the system may be evolved manually by an assessor, or automatically by the system. In some embodiments, the system creates a new rubric to facilitate the categorization of the non-matching assessment, or amends existing rubrics by adding criteria, scores, and/or benchmarks.

For example, consider that the student (Johnny) is giving an oral presentation. The teacher records a video of Johnny's presentation. One possible criteria, “Confidence”, is not present in the existing “Oral Presentation” rubric 100. This criteria can be manually added by an assessor, or automatically added by the system, to a rubric.

If the assessment does not fit into currently available rubrics, rubrics may be evolved manually or automatically. By “evolving” rubrics what is meant is that new rubrics are created to facilitate the categorization of the assessment, or existing rubrics are amended by updating criteria, scores, and/or benchmarks.

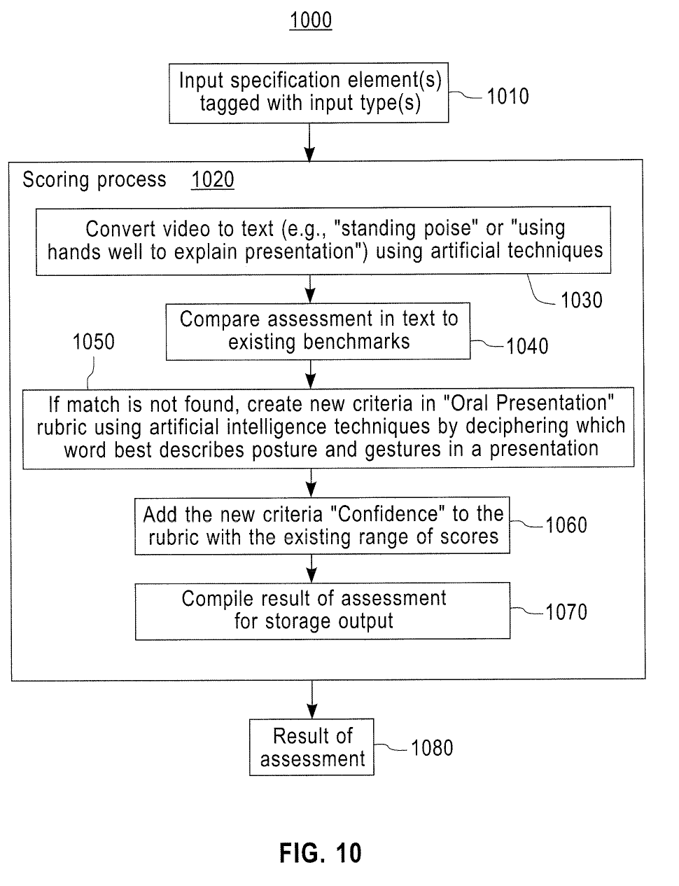

For example, consider that Johnny is giving an oral presentation. The teacher takes a video of Johnny's oral presentation. One of the criteria that the system can assess Johnny is on “Confidence”, but this criteria is not present in the existing “Oral Presentation” rubric 100. This can be manually or automatically added to the rubric. The steps for this example are represented in FIG. 10. An explanation is given below:

a. The input specification includes a video of Johnny giving his presentation.
b. The classification process parses out the input specification elements and tags them with input types.
c. The input to the scoring process is the textual representation of the name of the person (“Johnny”) which was obtained by the system by matching the picture of Johnny with an existing picture in its database. The input is also the posture and gestures used by Johnny during his presentation to assess “Confidence”.
d. The scoring process attempts to match the posture and gestures with existing benchmarks known to the system, such as by:

Converting posture and gestures into a text representation (format) consistent with existing benchmarks known to the system. Possible outcomes could be “standing poise” and “using hands well to explain the presentation”.

Comparing these possible outcomes with all benchmarks known to the system.

e. If no match was found in the “Oral Presentation” rubric 100 (or any other rubric known to the system if the system searched all known rubrics).
f. The system creates a new criteria “Confidence” in the “Oral Presentation” rubric 100. This criteria could be created by the system after performing artificial intelligence techniques to find the beest word describing posture and gestures.
g. The same range of scores are assigned to “Confidence” (from “Poor” to “Excellent”).
h. The system, using for example some intelligence algorithm, deciphers that Johnny's score on “Confidence” should be “Excellent”.
i. The result of the match is provided as input to the storage output (see next section) process for storing in persistent medium.
j. Hence, Johnny has been assessed on his presentation confidence.

At step ‘f’, in some embodiments, the process may be manual in that the system may prompt the teacher to evolve a rubric as she/he desires. This is only an example of an evolving a rubric, and this may involve any combination of input specifications in any input types with the use of existing or similar algorithms to decipher the creation of evolved rubrics.

FIG. 10 is a block diagram 1000 that illustrates an example of the scoring process 1020 for evolving rubrics. The input 1010 to the scoring process 1020 is one or more input specification elements that are tagged with input type(s) 1010. One example of the scoring process 1020 is shown here where the input specification elements 1010 are:

Name of the person to be assessed: Johnny
Input type: video
Assessment: video (or pictures extracted from video) of various postures and gestures

The output of this process (result of assessment) 1080 is provided to the storage output process where the results are stored, preferably in some persistent medium.

As shown, one or more input specification elements tagged with input types(s) 1010 are provided as input to the scoring process 1020. The scoring process 1020 converts the video to text (e.g., “standing poise” or “using hands well to explain presentation”) using artificial intelligence techniques 1030. Next, the assessment now represented as text is compared to existing benchmarks 1040. If a match to an existing benchmark is not found, create new criteria in the “Oral Presentation” rubric 100 using artificial intelligence techniques by deciphering which word best describes posture and gestures in a presentation 1050. Next, add the new criteria “Confidence” to the rubric with the existing range of scores 1060. Next, compile the result of assessment for storage output 1070. Next, output the result of the assessment from the scoring process 1080.

### Storage Output

After completing the scoring process, the assessment results are preferably stored in permanent or persistent storage, for example, a database, file, or any other medium. The information that the storage can maintain is the following:

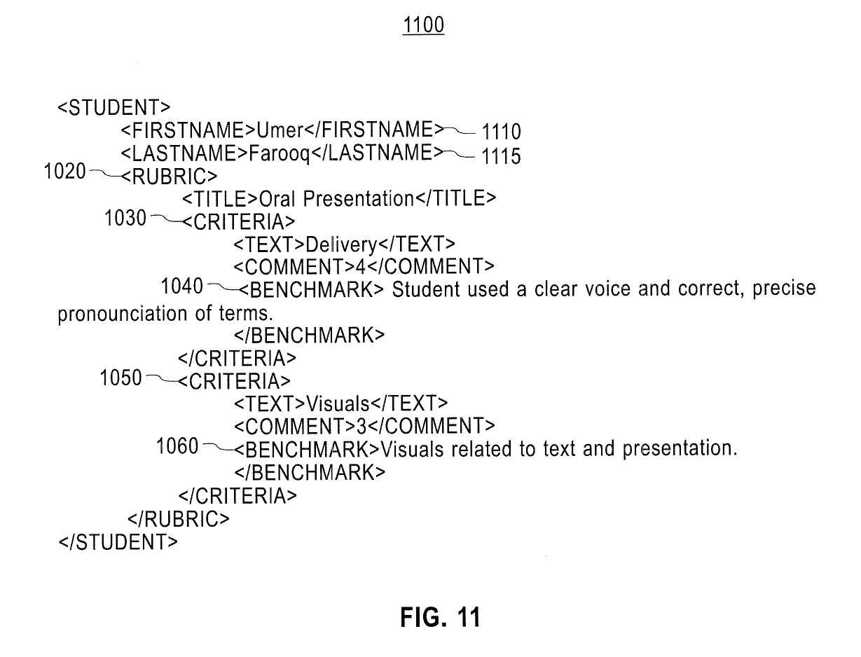

1. Rubrics: details of rubrics as specified in FIG. 1. Rubrics can be stored in any electronic format such as is shown in FIG. 2.
2. Student information: student identifiers (e.g., name, picture, etc) and associated rubrics (see FIG. 11 for details).

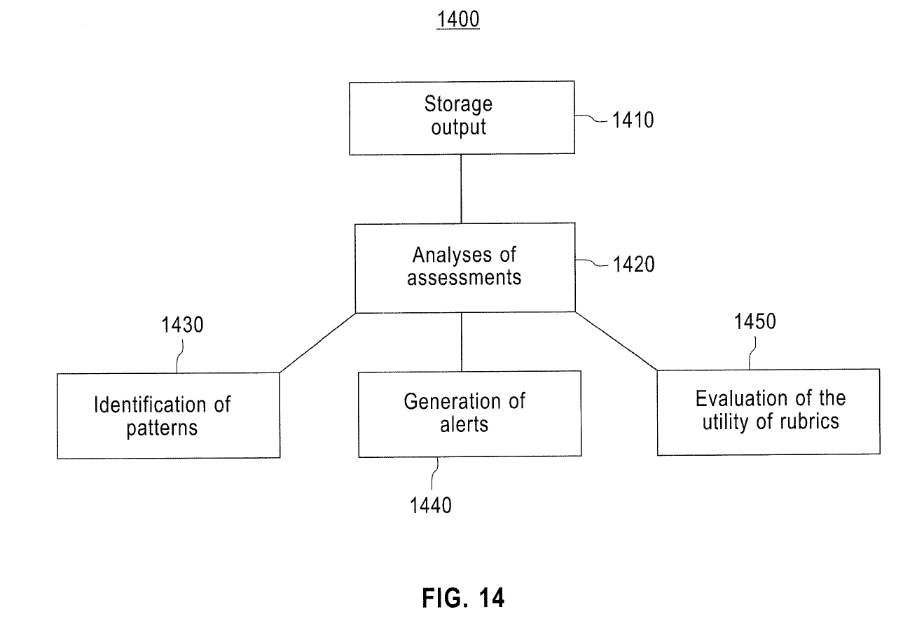

The stored data is not only limited to this information. Any information related to the above two fields and/or that has a bearing on the assessment process can be stored. For example, the storage can also contain demographic data about the student (e.g., gender, age, etc) for analyzing the assessments according to these fields. The rubric assessments and/or assessment results can also be tagged with the time and date of assessment so the teacher can use this data for identifying and analyzing patterns (see FIG. 14 in this regard).

If the rubrics are being evolved, the new fields (rubric elements) are also stored. In some embodiments, any change in current information is stored and tagged with a date and time. The system can also use existing techniques to organize the information in a coherent and presentable manner.

FIG. 11 is an illustration 1100 of an example of student information represented in Extensible Markup Language (XML) format. The XML format is another one of many ways to represent student information. In this example, student information is represented in XML format in which the student identifier is a name identified with XML tags <FIRSTNAME> 1110 and <LASTNAME> 1115 in the XML text 1100. Alternatively, the student identifier could be a picture (image), video, audio, or any input type as specified previously. Note that the format of the associated rubric elements <CRITERIA> 1030, 1050 and <BENCHMARK> 1040, 1060 are also tagged with XML text.

Alternatively, rubric elements 1030, 1040, 1050, 1060 could be represented by (images) pictures or any other input types as specified previously.

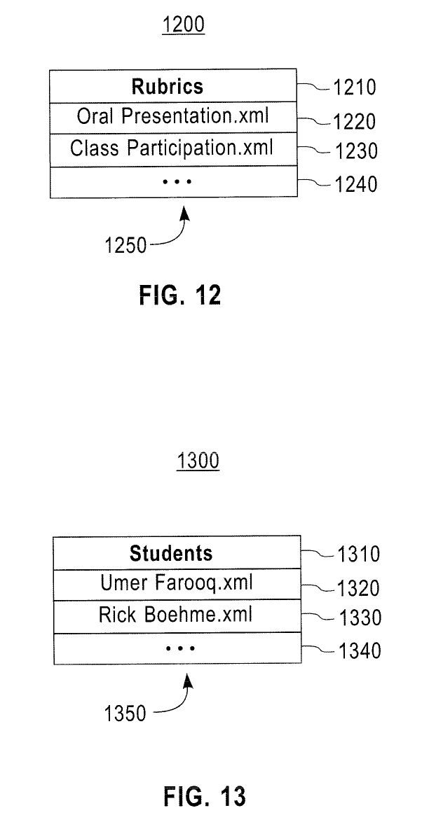

FIG. 12 is a block diagram 1200 that illustrates an example of storing rubrics represented in XML format. In this example, rubrics are stored in a file 1250 which contains links to all the accessible rubrics in XML format. As shown, the file 1250 named “Rubrics” 1210 includes a link to the “Oral Presentation.xml” rubric 1220 and a link to the “Class Participation.xml” rubric 1230. Links to other rubrics 1240 are included in this file 1250.

FIG. 13 is a block diagram 1300 that illustrates an example of storing student information represented in XML format. In this example, student information is stored in a file 1350 which contains links to all the information for a particular student in XML format. As shown, the file 1350 named “Students” 1310 includes a link to the “Umer Farooq.xml” 1320 (Student information for Umer Farooq) and a link to the “Rick Boehme.xml” student 1330 (Student information for Rick Boehme). Links to other student information 1340 are included in this file 1350.

### Analysis of Assessments

FIG. 14 is a flow diagram 1400 that illustrates analysis of assessments. Optionally, once storage output 1410 is complete, analyses of assessments 1420 can be performed by the system on the stored output data. Different types of analysis are shown. As shown, analysis of assessments can perform identification of patterns 1430, generation of alerts 1440 and evaluation of the utility of rubrics 1450. Types of analysis are further described below.

1. Identification of patterns: identifying various student patterns in the data.
a. Patterns could be related to assessments that have been stored and other student-related data. For example, assessments on a student's oral presentation rubric can be linked to a test performance for that student and vice versa.
b. Patterns could be related to various assessments in cross-rubric data. For example, assessments in a student's oral presentation rubric could explain some of the assessments made in the class participation rubric and vice versa.
c. Patterns could be related to various assessments in cross-subject data. For example, assessments in a student's oral presentation could explain some of the assessments made in a science class rubric and vice versa.
d. Patterns could be related to various assessments in historical data. For example, a student's assessments currently could be linked to his/her performance retrospectively and vice versa.
e. Generally, any type of patterns could be identified that provide leverage to the teacher in affecting a student's performance and/or acquiring an explanation of his/her performance. Patterns can also be correlations between various factors.
2. Generation of alerts: identifying student alerts in the data. Alerts are critical information that the teacher needs to be aware off in order to affect student's performance. The teacher may specify the alerts that he/she wants to be aware off using any interface technique.
a. Alerts could be group specific, i.e. an alert for the teacher that a group of students are performing poorly on a given test.
b. Alerts could be teacher specific, i.e. an alert for the teacher that he/she is paying too much attention to the students who are performing relatively well in class.
c. Alerts could be classroom management specific, i.e. an alert for the teacher to reorganize her lesson plan in order to effectively and efficiently finish all her lessons.
d. Generally, alerts could be any form of information that provides leverage to the teacher in affecting a student's performance and/or his/her own performance.
3. Evaluation of the utility of rubrics: evaluation of rubrics for understanding their effectiveness. This can be achieved in the following ways:
a. Comparison of student patterns related to rubrics to see whether automated rubric assessments have an effect on student's performance.
b. Self-evaluation for assessor by analyzing organizational capabilities with and without using automated rubrics for assessments.
c. Generally, evaluation of the utility of rubrics would be related to any information for the assessor that leads (or doesn't lead to) to effectiveness of using the automated rubrics for assessments.

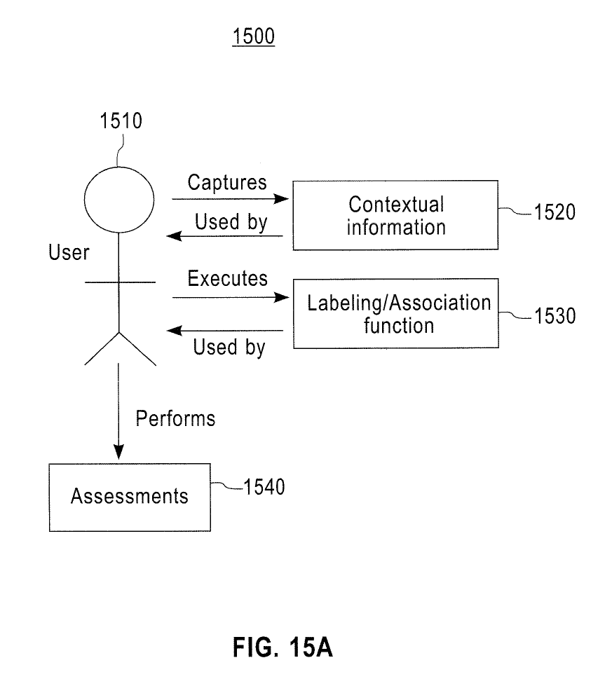

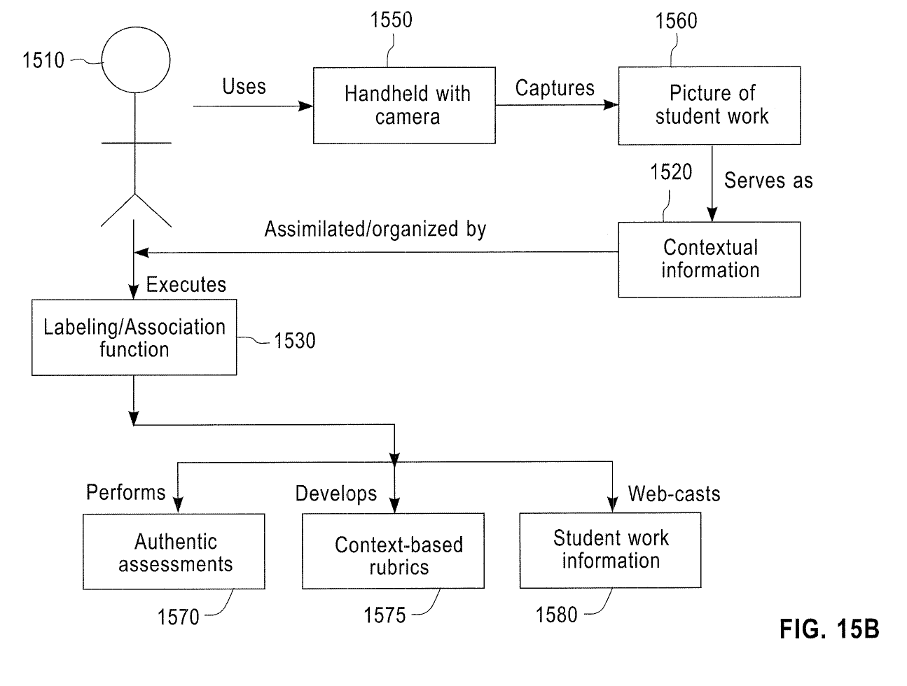

FIG. 15A is an illustration of a user capturing contextual information for use as an assessment. The user 1510, for example a teacher, captures contextual information 1520, such as her comments, using an apparatus (not shown) such as a PDA equipped with a microphone. The apparatus then executes a labeling/association functions 1530 upon the contextual information 1520, such as mapping her comments 1520 to a rubric (not shown). Processing of the contextual information performs an assessment 1540 which is preferably stored in a persistent medium.

FIG. 15B is an illustration of a user capturing a picture of student work via a camera for assessment, development of rubrics and Web-casting. The user 1510, for example a teacher, captures contextual information 1520, such as a still picture (digital image) of student work 1560, using a handheld camera 1550. An apparatus, such as aPDA (not shown) accesses the digital image and then executes a labeling/association function 1530 upon the digital image 1520, such as mapping the digital image 1520 to a benchmark within a rubric (not shown). Next, the output the labeling/association function 1530 is used to perform authentic assessment 1570, to develop context based rubrics 1575 or to Web-cast student work information 1580.

As an example, consider a teacher using a digital camera integrated into a handheld device to capture images (pictures) of a frog that a student dissected. As shown in FIG. 2, the teacher organizes such images and:

1. Performs authentic assessment by comparing various images to perform consistent grading;
2. Develops assessment criteria/standards/benchmarks for rubrics to be reused by other teachers;
3. Web-casts the images for student self-evaluation and for use by parents as progress Indicators.

The teacher also executes a labeling/association function to label the context individually or in batch using text, speech-to-text, or by associating it with another collection of information. The teacher can also associate the context with a particular student or set of students.

Authentic assessment, is the process of assessing students effectively by subjecting them to authentic tasks and projects in real-world contexts. Authentic assessments often require teachers to assess complex student performance along a variety of qualitative dimensions. Authentic assessment tools therefore are asynchronous, as teachers must reflect on student performance and record student assessments during post-class sessions. Teachers often lose vital contextual information about students and their interactions in class (e.g., did Johnny participate in group activities?) during the transition period from the class to when data is entered into the authentic assessment tools.

### Extensions and Applicability of the System

The automated system for assessment with rubrics in accordance with the teachings of this invention can be extended to a wide variety of other uses. First, there are described extensions of the automated system within the classroom, i.e., for teachers, and then, the applicability of this system to other domains (besides teaching). The extensions to the system within the classroom domain include the following:

1. Reuse by other teachers: this can be done in at least two ways.
a. Reuse of student assessments: student assessments can be reused by different teachers who are teaching the same students that were taught by teachers before who used this automated system for assessments. For example, if Johnny decided to change schools, his assessments from his former school A can be reused by his new teachers in school B, thus saving time in understanding the student's profile and becoming more efficient in developing a personal agenda for the new student.
b. Reuse of rubrics: rubrics developed for students can be reused by other teachers for their curricula/classes. These rubrics could be in their original form or evolved as teachers update these rubrics to adapt to class dynamics. For example, a teacher in school A teaching science can reuse the rubric developed by teacher in school B who also teaches science. This leads to the notion of teachers sharing their resources in a potentially collaborative manner and a way to leverage off each others' experiences.
c. Reuse in any other form that uses previous data collected from this automated system or otherwise.
2. Casting assessment-related data to other repositories: this implies the portability of collected data to other repositories for viewing and/or reuse. For example, the student assessment data collected by teachers can be uploaded to the school web site for the following reasons:
a. Students would like to self-evaluate by reflecting on teacher's assessments.
b. Parents would like to receive regular updated information in a universal manner (the Internet) about their child's performance in school.
c. Administrators would like the teachers to organize the information in a coherent manner.
d. For purposes of organizational convenience and/or public access points.

This process of casting assessment-related data to other repositories may be automated, e.g., the student assessments are automatically uploaded to a school web site as soon as the teacher records her assessments. The process of organizing the information can also be automated using existing techniques.

3. Rubric assessment: this system can be used to assess the rubrics itself in an attempt to clarify the validity of its use. For example, it may happen that the wrong rubric is being used for a particular task or person. An instance of this could be that an “Oral Presentation” rubric 100 is being used for a student who is giving a speech—instead, a “Speech” rubric should be used. The automated system could detect these environmental conditions to weigh in the effect of these external factors. Another scenario of rubric assessment could be that an “Oral Presentation” rubric 100 is being used for a student who has a speech impediment—instead, a specialized rubric should be used for this student due to the nature of the specialized task.
4. Multiple modes of system use: the system can be used in at least three ways.
a. Assessor uses the system to evaluate others (e.g., teacher uses the system to evaluate students).
b. Assessor uses the system for self-evaluation (e.g., student uses the system to assess his/her own performance). This is an example of using this automated system to train a user, e.g., teacher training and/or student training. The teacher can use the system to train him/herself on how to use rubrics in authentic settings. Similar is the case with students who wish to train themselves for authentic tasks, e.g. preparing an oral presentation.
c. An automatic process uses this system to evaluate others (e.g., a video camera assessing students without the help of a teacher). In this case, the automated system has been programmed to assess a subject without the assistance of any other entity. This is also another form of training as in ‘b’ above.
d. Any mode of use that utilizes the functionality of this automated system.
5. Identification and development of specialized rubrics: this implies the use of specialized and/or customized rubrics for a particular student(s). Each person could have a customized rubric instead of just one, since grades are relative. For example, Johnny's “Excellent” does not mean the same as Bob's “Excellent”, although the rubric domain was the same and they were assessed on the same topic. Another example would be to consider a criteria in some rubric that says “Improved performance”, which is relative to a student's past performance; hence, each student would have a different interpretation of “Improved performance”, and thus, a different rubric. The automated system could play two roles in this regard:
a. Identify the use of specialized rubrics: the system could automatically detect whether or not the same rubric should be used or not for a particular student(s). This could be done on the basis of existing data in the storage. Any existing technique such as data mining could be used. An example could be that Johnny had a “Poor” score 125 on his “Oral Presentation” rubric 100, but Bob had a “Good” score 140; however, they both scored the same overall on their presentations, which means that Johnny's “Poor” score 125 is about the same as Bob's “Good” score 140, thus warranting the use of separate rubrics for both the students.
b. Development of specialized rubrics: the system, perhaps after identification (the step above in ‘a’), could develop specialized automatic rubrics for teachers. For example, in case of Johnny's and Bob's scenario above in ‘a’, the system could make different rubrics for both the students. Hence, when the teacher assesses Johnny, his rubric would be used instead of a general rubric for the whole class, and similarly with Bob.
6. Using these assessments, generate automatically grades (letter, numeric, etc) based on previous assignment of grades. This automated system thus will have a “translation” algorithm that will translate all the student assessments into grades. Hence, looking at the overall system, if the teacher specifies assessments for Johnny's oral presentation, this is automatically translated to a letter grade (this is just one example in which a grade could be assigned).

The automated method of ranking learner assessment into rubric scores can be applied to settings other than classrooms, i.e. in any domain that requires assessment to be performed. The automation system process is similar to the one as used by teachers in classrooms. Of course, rubrics can be generalized to any type of assessment hierarchy with different criteria, scores (ranking), and/or benchmarks. For example, this system can be used in some of the following ways:

1. Administrators (school or otherwise) can use this system to assess teachers and their performance.
2. Managers use this system to assess employees and their productivity.
3. Government agencies use this system to establish efficiency of various umbrella organizations, workers, operations, etc.
4. Doctors and/or nurses can use this system to establish symptoms and conditions for patients. For example, nurses can take a picture of a wound and the system could automatically describe the disease, or perhaps the symptoms are identified and the cure/medication is suggested by the system. These suggestions could be based on previous records of the same symptoms/conditions.
5. An organizational analysis is possible, where rubrics are aggregated using the bottom-to-top approach. For example, the rubrics for assessing teachers are used to assess the administrators of the school, whose rubrics are then used by some state program to assess school performance, whose rubrics are then used at a federal level to assess school performance at a national level.
6. The system can be used for conditional analysis for using specialized rubrics. For example, if a patient is diabetic, the alarm for that patient sounds at a different temperature than for a non-diabetic patient. This uses the same concept of specialized rubrics as in the classroom settings.

In some embodiments, the invention is computer system capable of the automated assessment of people, standards, and/or environments. Using this system, the process of assessment is improved relative to a manual process in terms of time, efficiency, effectiveness, consistency, assessment aggregation, assessment organization, accurate evaluation, and/or other comparable factors. In some embodiments, the system includes a process which includes the steps of assessment input, classification, scoring, and/or storage output.

Optionally, the process (of the system) includes the step performing an analysis of assessments. Depending on the type of embodiment, any of these steps are automated and/or manual. The assessment input may be any type of input, one or multiple (inputs), including data from data collection, manual or automated mechanisms.

The system can be used by any entity for assessing any entity. An entity can be a person, a computer, and/or any entity that requires assessment. Assessing may be performed in different ways such as an assessor assessing other entities, an assessor performing self-assessment, an automated system assessing other entities, and/or any combination of entities assessing other entities.

In some embodiments, the process of assessment is automated using rubrics. Optionally, a rubric can be translated to a grade. A grade can be any overall representation of an assessed rubric that maybe in the form of a percentage, letter, numeric, or other metric that conveys similar information.

A rubric is any standard for assessment. A rubric may be represented in any computer-readable format and/or human-readable format such as Extensible Markup Language (XML), tabular, or any other format. A rubric may consist of an identifier, assessment criteria, assessment scores, and/or assessment benchmarks and a rubric may be nested with other rubrics. Optionally, identifiers, assessment criteria, assessment scores, and/or assessment benchmarks may be represented by multiple levels such as by multi-dimensional data, menus, and similar levels of representation. A rubric can be translated to a grade.

Identifiers, assessment criteria, assessment scores, and/or assessment benchmarks may be represented in any machine readable, computer-readable format and/or human-readable format such as audio, video, text, multimedia, or other format. Identifiers, assessment criteria, assessment scores, and/or assessment benchmarks may be pointers to other data such as hyperlinks. Optionally, assessment input may be tagged with input types. The assessment input may include an input type, input specification, and/or any other dimensions of information that suffice as input to the system.

In some embodiments, the input type is any format of input to the system such as written freehand comment, written typed comment, audio, video, still picture, multimedia, and/or any input that can be interpreted in electronic/computer-readable format. The input type can be provided as input to the system through an input mechanism such as a microphone, video camera, still camera, stylus graffiti, keyboard, mouse, and/or any similar input devices that interface with a computer.

In some embodiments, the assessment specification can be any form of input to the system such as an assessment, name, rubric, criteria, score, benchmark, and/or any specification that conforms to any supported input types.

In some embodiments, the assessment input specification is mandatory. Optionally, the assessment input specifications can be nested, i.e. they can be provided as combinations of input specifications (input specification elements). In some embodiments, the assessment specification can be extracted from existing data repositories such as a teacher's lesson plan book and/or from input mechanisms such as video camera, microphone and other information input mechanisms. The input specification can be represented for input purposes using any computer interface technique such as text boxes, dialog boxes, forms, information visualization, and/or similar techniques.

In some embodiments, the classification process parses input specification and tags the input specification with an appropriate input type for the subsequent processing. The classification process deciphers the input type using artificial intelligence, natural language processing, speech recognition, and/or any technique to decipher the input type(s) (types of input representation). The classification process separates and identifies the input specifications (input specification elements) for the subsequent processing.

In some embodiments, the scoring process scores the assessment for an entity being assessed and determines which portion of rubric information that the assessment matches to. The scoring process matches the input specification(s) (input specification elements) with the available data, including rubric data.

In some embodiments, matching is done by first converting data in compatible/comparable Formats using speech-to-text techniques, artificial intelligence, and/or similar techniques that will allow the system to compare data represented in equivalent formats.

In some embodiments, the result of the scoring process is input to a subsequent system process. In some embodiments, the matching is done at various levels (of rubric data) depending on the information content of the input specifications (input specification elements).

In some scenarios, the matching step may result in an assessment not fitting into (not matching data of) system-known rubrics. In these scenarios, new rubrics can be created, old (existing) rubrics can be updated (modified/evolved), and/or other suitable action taken by the system. Any portion of a rubric may be changed (modified) to form an evolved rubric. Evolved rubrics may be created using artificial intelligence, format conversion techniques, and/or any similar techniques that lead to the creation of evolved rubrics.

In some embodiments, the storage output is a process that stores data output from previously executed steps (such as data from assessments, rubrics, and/or any other data generated by system that is required (desired) to be recorded). Optionally, the storage output process can store data in Extensible Markup Language (XML) format, database, and/or any computer-readable or human-readable format. The storage output process can store data that is related to assessments or that may be associated with assessments.

In some embodiments, analysis can be performed on the system data manually or automatically. The automated analysis can result in identification of patterns within the data. The identification of patterns can be related to student-related data, cross-rubric data, cross-subject data, historical data, and/or any type of patterns that provide leverage to the assessor in affecting the performance and/or acquiring an explanation of the entity being assessed. Patterns can be correlations between different data factors. Optionally, the automated analysis can result in the generation of alerts. The generation of alerts can be related to critical information that the assessor needs to be aware off in order to affect the performance of the assessor and/or entity being assessed. The critical information can be related to group-specific data teacher-specific data, and/or any information that provides leverage to the assessor in affecting the performance of the assessor and/or the entity being assessed. The automated analysis can result in the evaluation of utility of rubrics. The evaluation of the utility of rubrics assesses the effectiveness of rubrics. The evaluation of utility of rubrics can be performed by analyzing data using data mining techniques and/or any similar technique that may or may not lead to information about effectiveness of the system.

The system can be used in various domains and for applications that require assessments to be performed such as a school system, a university, company, and/or any entity that can be assessed. System data can be reused by other entities. Reuse can be related to student assessments, rubrics, and/or any previous data or implications from the system data. System data can be leveraged to other repositories (such as the uploading of the data to the Internet) for reuse.

In some embodiments, system data is automatically leveraged to other repositories and/or system data is automatically organized for reuse. Optionally, system data can be used for rubric assessment. Rubric assessment can establish the validity of the use of rubrics and/or use of rubrics for any entity or entities.

In some embodiments, system data can be used to develop specialized rubrics. Specialized rubrics are customized rubrics for specific entities or a group of entities. Optionally, the system identifies the use of specialized rubrics. Optionally, the identification of specialized rubrics use data mining techniques and/or any technique that establishes relationships in the data leading to the use of specialized rubrics. In some embodiments, conditional analysis uses specialized rubrics.

In some embodiments, administrators can use the system to assess their workers and/or managers can use this system to assess their employees. Also, doctors/nurses can use this system to establish symptoms for patients. The system can be used for organizational analysis and assessment. In general, the system that is constructed and operated in accordance with this invention may be used for any purpose related to any type of assessment in any domain.

In some embodiments, the invention is a method and apparatus for capturing contextual information, optionally through a portable ingestion device, for assessment in a learning environment.

Any recording media can be used to capture contextual information. In some embodiments, the context of information can be labeled individually or collectively using text and/or speech information, or by association with other data. Context can be associated with a particular learner or set of learners. Optionally, the method and apparatus further includes using contextual information for retrieving, assimilating, organizing and/or for making inferences for any type of assessment, be it opinions and/or reflective development.

This method and apparatus can be used in any environment that requires the use of any type of assessment. The method and apparatus further includes using contextual information for developing context-based rubrics for intra-assessment and inter-assessment, communicating with interested parties and/or facilitating instruction.

In some embodiments, capturing contextual information includes recording the contextual information and reflecting on the contextual information for further fragmentation, assimilation and/or for making inferences in association with the labeling of the contextual information.

In some embodiments, the method and apparatus further includes integrating/automating contextual information with assessment tools. Optionally, the method and apparatus further includes reflecting on previously made assessments with contextual information for assessment in association with the labeling of the contextual information. In some embodiments, the method and apparatus further includes identifying patterns based on contextual information.

As was noted earlier, this invention may be embodied as procedure expressed in computer program code on a medium that is readable by a computer. The program code is used to direct operation of a computer for assessing an entity, and includes a program code segment for selecting a rubric having associated rubric information; a program code segment for inputting assessment input information associated with an entity; a program code segment for mapping said assessment input information to said rubric information to yield results of the mapping; and a program code segment for storing said results of said mapping. The entity may be a human entity, such as a student, patient or an employee, as non-limiting examples, or the entity may be a non-human entity, such as a business entity or a component part of a business entity (e.g., corporation, or a group or a department within a corporation, as non-limiting examples), or a process or a procedure, such as a manufacturing process, an accounting process and a medical process, as non-limiting examples.

In a preferred embodiment the rubric comprises an identifier, at least one criterion, at least one score representing an assessment value of the at least one criterion, and at least one benchmark representing an exemplary standard of assessment that has been assigned to the at least one criterion and associated score.

It is noted that at least two of the program code segments may operate on different computers, and may communicate over a data communications network.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent benchmarks, input devices and input types, classification categories and procedures and scoring procedures may be attempted by those skilled in the art. However, all such and similar modifications of the teachings of this invention will still fall within the scope of this invention.

Furthermore, some of the features of the present invention could be used to advantage without the corresponding, use of other features. As such, the foregoing description should be considered as merely illustrative of the principles of the present invention, and not in limitation thereof.

What is claimed is:

1. A method to assess an entity comprising:
selecting a rubric having associated rubric information;
inputting assessment input information associated with an entity;
mapping said assessment input information to said rubric information to yield results of said mapping; and
storing said results of said mapping.

2. The method of claim 1, where said rubric information includes at least one benchmark, at least one criteria associated with each said at least one benchmark, and at least one score associated with each said at least one benchmark.

3. The method of claim 1, where said assessment input information includes an assessment element, and where mapping said assessment input information to said rubric information includes mapping said assessment element to at least one matching benchmark included within said rubric information.

4. The method of claim 3, where mapping said assessment input information to said rubric information includes mapping said assessment input information to said at least one matching criteria and to said at least one matching score associated with said matching benchmark.

5. The method of claim 1, where said assessment input information is represented by any machine readable representation including multimedia, audio, video, images, still pictures, type and freehand writing, and any representation that can be interpreted in electronic format.

6. The method of claim 1, where said assessment input information includes an identification of a combination of the entity, the input type and the rubric.

7. The method of claim 1, where said assessment input information is extracted from at least one data repository.

8. The method of claim 1, where mapping said assessment input information to rubric information employs an information deciphering methodology that comprises at least one of artificial intelligence, natural language processing with speech recognition, hand writing recognition and text scanning.

9. The method of claim 4, where storing the results of the mapping includes storing said matching score and any combination of said matching benchmark, said matching criteria, identification of said entity and of said rubric.

10. The method of claim 4, where mapping the assessment input information to rubric information creates a new benchmark within said rubric information during mapping of said assessment input information to said matching benchmark.

11. The method of claim 4, where mapping the assessment input information to rubric information creates at least one new criteria within said rubric during mapping of said assessment input information to said matching criteria.

12. The method of claim 4, where mapping the assessment input information to rubric information creates a new rubric during mapping of said assessment input information to said matching benchmark.

13. The method of claim 1, further comprising analyzing the results of said mapping by an examination of at least one of patterns, correlation of said patterns, generation of alerts and the evaluation of the utility of said rubric based upon results of the mapping.

14. The method of claim 1, where inputting assessment input information associated with an entity precedes selecting a rubric having associated rubric information, said assessment input information including information identifying said rubric.

15. Apparatus to assess an entity, comprising a selection unit to select a rubric having associated rubric information, an input unit to input assessment information associated with an entity, a mapping unit to map said assessment input information to said rubric information to yield a mapping result and a storage medium to store said mapping result.

16. The apparatus of claim 15, comprising a data processor executing software to implement at least a portion of one or more of said selection, inputting and mapping units.

17. The apparatus of claim 15, where said inputting unit comprises a microphone for input and storage of audio information.

18. The apparatus of claim 15, where said inputting unit comprises a camera for input and storage of video information.

19. The apparatus of claim 15, comprising a communications port for communicating information between the apparatus and a location remote from the apparatus.

20. The apparatus of claim 19, where said storage medium is at least one of local to or remote from said apparatus.

21. The apparatus of claim 15, embodied by a portable computing device.

22. The apparatus of claim 15, where said input unit captures contextual information for use in developing at least one context-based rubric.

23. The apparatus of claim 15, where said assessment input information comprises a machine readable representation that comprises at least one of multimedia, audio, video, images, still pictures, typeset and freehand writing and any representation that can be interpreted in electronic format.

24. The apparatus of claim 15, where said mapping unit implements an information deciphering methodology that comprises at least one of artificial intelligence, natural language processing with speech recognition, hand writing recognition and text scanning.

25. The apparatus of claim 15, further comprising an analysis unit coupled to said storage unit to analyze said mapping result by at least one of an identification of patterns, a correlation of patterns, a generation of alerts and an evaluation of a utility of said rubric based upon said mapping results.

26. The apparatus of claim 15, where said rubric information comprises at least one benchmark, at least one criteria associated with each at least one benchmark, and at least one score associated with each at least one benchmark.

27. The apparatus of claim 26, where said assessment input information comprises an assessment element, and where said mapping unit maps said assessment element to at least one matching benchmark included within said rubric information.

28. The apparatus of claim 27, where said mapping unit further maps said assessment input information to at least one matching criteria and to at least one matching score associated with said matching benchmark.

29. The apparatus of claim 19, where said assessment input information is extracted and communicated to at least one data repositories.

30. A procedure embodied as program code on a medium that is readable by a computer, the program code being used to direct operation of a computer for assessing an entity, the program code comprising
a program code segment for selecting a rubric having associated rubric information,
a program code segment for inputting assessment input information associated with an entity;
a program code segment for mapping said assessment input information to said rubric information to yield results of said mapping;
a program code segment for storing said results of said mapping.

31. A procedure as in claim 30, where said entity is a human entity.

32. A procedure as in claim 31, where said entity is a student.

33. A procedure as in claim 31, where said entity is a patient.

34. A procedure as in claim 31, where said entity is an employee.

35. A procedure as in claim 30, where said entity is a non-human entity.

36. A procedure as in claim 35, where said entity is a business entity or a component part of a business entity.

37. A procedure as in claim 35, where said entity is a process.

38. A procedure as in claim 37, where said process is one of a medical process, a manufacturing process and an accounting process.

39. A procedure as in claim 30, where said rubric comprises an identifier, at least one criterion, at least one score representing an assessment value of the at least one criterion, and at least one benchmark representing an exemplary standard of assessment that has been assigned to the at least one criterion and associated score.

40. A procedure as in claim 30, where at least two of the program code segments operate on different computers, and communicate over a data communications network.
